(19) United States
(12) Patent Application Publication
(10) Pub. No.: US 2012/0233833 A1
(43) Pub. Date: Sep. 20, 2012

(54) Method for Handlebar Mount Bicycle Componentry Alignment Tool

(76) Inventor: Christopher Cobi BALSER, Minneapolis, MN (US)

(21) Appl. No.: 13/421,746

(22) Filed: Mar. 15, 2012

Related U.S. Application Data
(60) Provisional application No. 61/452,743, filed on Mar. 15, 2011.

(51) Int. Cl. B23P 11/00

(52) U.S. Cl. 29/407.1

(57) ABSTRACT

A method of handlebar mount bicycle componentry alignment tool comprises the steps of aligning a plurality of bicycle components. The plurality of bicycle components comprises a front wheel or tire, a saddle, a left and right gear system, and a left and right brake system. The front wheel or tire is aligned relative to the handlebar and the saddle is also aligned relative to the handlebar. The left and right gear system and the left and right brake system also align relative to the handlebar, each other, and/or specific angles.

The current application claims a priority to the U.S. Provisional Patent application Ser. No. 61/452,743 filed on Mar. 15, 2011.

### FIELD OF THE INVENTION

The present invention relates generally to a method for a bicycle attachment. More particularly, the present invention is a method for mounting a device to a bicycle handlebar to align bicycle components relative to handlebar position.

### BACKGROUND OF THE INVENTION

Bicycle componentry alignment is integral to proper assembly, maintenance, and position. Bicycles are unique in that a front wheel or tire is adjusted relative to bicycle handlebar stem and bicycle handlebar for proper alignment. Existing tools for aligning one's bicycle parts include, but are not limited to, visually estimating of positioning, which easily allows for human error. It is therefore an object of the present invention to introduce a method for bicycle handlebar mounting device to align bicycle components relative to the bicycle handlebar, providing a perpendicular axis to the front wheel or tire, saddle, brake levers and shifter levers. The perpendicular axis is provided from an alignment device which is attached to the mounting device.

### BRIEF DESCRIPTION OF THE DRAWINGS

FIG. 1 is a flow chart illustrating the method of aligning bicycle componentry relative to bicycle handlebar.

FIG. 2 is a flow chart illustrating the method of aligning the plurality of left and right handlebar components relative to bicycle handlebar.

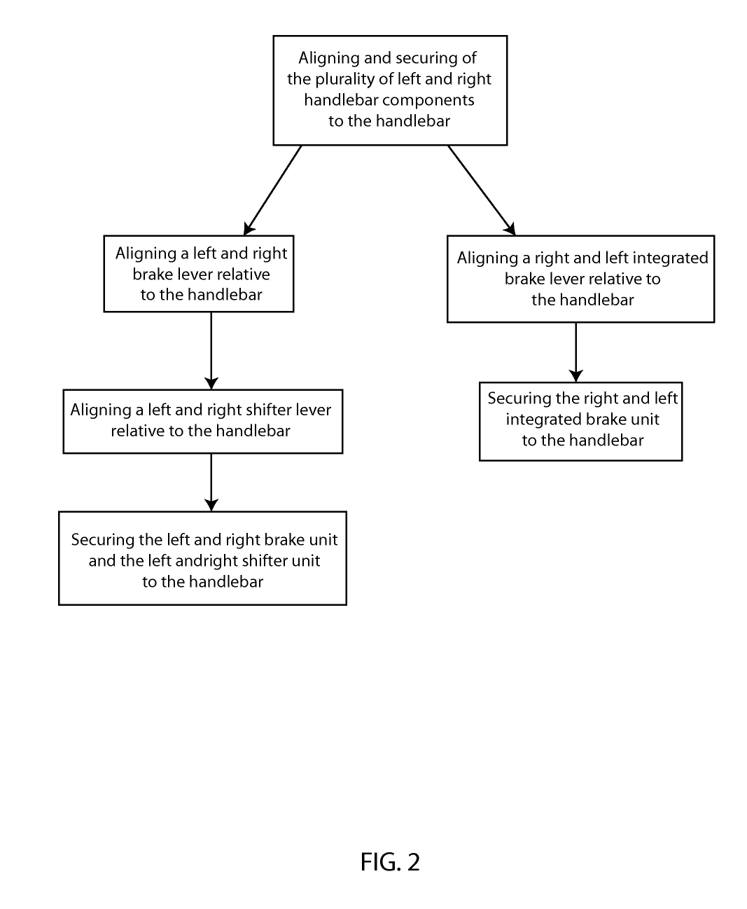

### DETAIL DESCRIPTIONS OF THE INVENTION

All illustrations of the drawings are for the purpose of describing selected versions of the present invention and are not intended to limit the scope of the present invention.

The present invention is a unique method of aligning a plurality of bicycle components perpendicular to a handlebar by use of an alignment tool which is mounted to the handlebar. The handlebar is centrally attached to a handlebar stem and the handlebar stem is attached to a fork steer tube. The handlebar stem and the fork steer tube are positioned within a head tube of a bicycle frame. Because of the present invention, the plurality of bicycle components is able to align with the handlebar with perfect symmetry. The plurality of bicycle components comprises a front wheel or tire, a saddle, a plurality of left handlebar components, and a plurality of right handlebar components. The plurality of left handlebar components comprises a left brake unit, a left shifter unit, and a left shifter with integrated brake unit. The left brake unit and the left shifter unit comprise a left brake lever and a left shifter lever respectively. The left shifter with integrated brake unit comprises a left integrated brake lever. The plurality of right handlebar components comprises a right brake unit, a right shifter unit, and a right shifter with integrated brake unit. The right brake unit and the right shifter unit comprise a right brake lever and a right shifter lever respectively. The right shifter with integrated brake unit comprises a right integrated brake lever.

The present invention can be implemented to any style of handlebar, such as drop style, flat or riser style, upright style, porteur style, touring or trekking style, triathlon or aero style, cruiser style, and moustache style. Even though these different handlebars comprise different shapes, the present invention can be used to align the plurality of bicycle components.

In order to align the plurality of bicycle components, the alignment tool is attached to a mounting device and the mounding device is attached or held to the handlebar. The attachment between the mounting device and the handlebar is provided by a locking mechanism or the mounting device is manually placed on the handlebar. The locking mechanism can be a manually positioned rubber straps, a mechanical locking system, or a manually positioned clamp system with plurality of bolts and nuts. The mounting device is shaped to provide equal surface contact so the mounting device attaches to the right side and the left side of the handlebar with perfect balance. Main function of the alignment tool is to align the plurality of bicycle components relative to the handlebar. The alignment tool can be a laser unit, a cord alignment device, a chain alignment device, or any kind of mechanical alignment device. The alignment tool used in the present invention comprises the functionality of creating a perpendicular axis of the bicycle frame and components, relative to the handlebar, for alignment purpose.

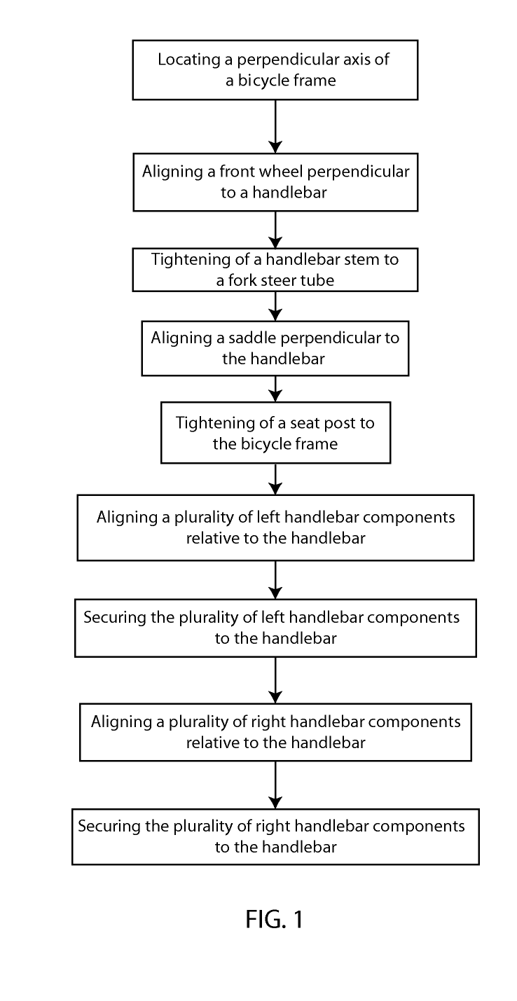

In reference to FIG. 1, the alignment tool is activated or used to locate a perpendicular axis of the bicycle frame relative to the handlebar. With the use of the perpendicular axis of the bicycle frame, the front wheel or tire, which is attached to a fork, is aligned relative to the handlebar stem. At the same time, the front wheel or tire is aligned perpendicular with the handlebar. The fork comprises the fork steer tube which attaches with the handlebar stem. After the front wheel or tire is aligned, the handlebar stem is tightened to the fork steer tube. Then the alignment tool is used to align the saddle where the saddle is attached to a seat post. The seat post adjusts the height of the saddle and the rotation of the saddle. After the saddle is aligned perpendicular to the handlebar where the saddle is also positioned parallel with the perpendicular axis of the bicycle frame, the seat post is tightened to the bicycle frame by a bicycle seat post clamp. The bicycle seat post clamp functions as a securing device to the seat post so the tightening of the seat post is simplified. Then the left brake lever and the left shifter lever, or the left integrated brake lever is aligned relative to the handlebar by using the alignment tool. Since each different handlebar comprises a unique shape, the plurality of left handlebar components may also align with specific angles relative to the handlebar or relative to each individual component. After the alignment of the left brake lever and the left shifter lever, or the left integrated brake lever is completed, the aligned components are secured to the handlebar. Then the right brake lever and the right shifter lever, or the right integrated brake lever is aligned relative to the handlebar by using the alignment tool. Since each different handlebar comprises a unique shape, the plurality of right handlebar components may also align with specific angles relative to the handlebar or relative to each individual component. After the alignment of the right brake lever and the right shifter lever, or the right integrated brake lever is completed, the align components are secured to the handlebar.

Certain components in the plurality of left handlebar components and the plurality of right handlebar components may depend on the different type of bicycles. For example, upright type of handlebar can be equipped with the left brake lever, the right brake lever, the left shifter lever, and the right shifter lever. At the same time, different upright type of handlebar can be equipped with the left integrated brake lever and the right integrated brake lever. Some of the handlebars, such as conventional drop style handlebars may comprise a plurality of left brake levers and a plurality of right brake lever for improved functionality. Even though the plurality of left and right brake levers positioned in two different angles, the plurality of left and right brake levers can be aligned relative to the handlebar with the alignment tool.

Although the invention has been explained in relation to its preferred embodiment, it is to be understood that many other possible modifications and variations can be made without departing from the spirit and scope of the invention as hereinafter claimed.

What is claimed is:

1. A method of aligning bicycle componentry relative to bicycle handlebar comprises the steps of:
1) providing a bicycle, wherein the bicycle comprises a bicycle frame, a handlebar stem, a handlebar, a fork, and a seat post;
2) providing a plurality of bicycle components, wherein the bicycle components comprises a front wheel or tire, a saddle, a plurality of left handlebar components, and a plurality of right handlebar components;
3) providing a mounting device, wherein the mounting device is attached to the handlebar;
4) providing a alignment tool, wherein the alignment tool is attached to the mounting device;
5) locating a perpendicular axis of the bicycle frame relative to the handlebar by using the alignment tool;
6) aligning the front wheel or tire perpendicular to the handlebar and relative to the handlebar stem, wherein the front wheel or tire is attached to the fork;
7) tightening of the handlebar stem to a fork steer tube, wherein the fork steer tube connected to the fork;
8) aligning the saddle perpendicular to the handlebar, wherein the saddle is attached to the seat post;
9) tightening of the seat post to the bicycle frame by a bicycle seat post clamp, wherein the bicycle seat post clamp functions as a securing device;
10) aligning of the plurality of left handlebar components relative to the handlebar, wherein the plurality of left handlebar components comprises components selected from the group consisting of a left brake unit, a left shifter unit, and a left shifter with integrated brake unit;
11) securing the plurality of left handlebar components to the handlebar;
12) aligning of the plurality of right handlebar components relative to the handlebar, wherein the plurality of right handlebar components comprises components selected from the group consisting of a right brake unit, a right shifter unit, and a right shifter with integrated brake unit; and
13) securing the plurality of right handlebar components to the handlebar.

2. The method of aligning bicycle componentry relative to bicycle handlebar as claimed in claim 1, wherein the alignment tool comprises components selected from the group consisting of a laser unit, a cord alignment device, a chain alignment device, and mechanical alignment device.

3. The method of aligning bicycle componentry relative to bicycle handlebar as claimed in claim 1 further comprises the steps of:
aligning a left brake lever relative to the handlebar, wherein the left brake lever is attached to the left brake unit;
aligning a left shifter lever relative to the handlebar, wherein the left shifter lever is attached to the left shifter unit; and
securing the left brake unit and the left shifter unit to the handlebar.

4. The method of aligning bicycle componentry relative to bicycle handlebar as claimed in claim 1 further comprises the steps of:
aligning a left integrated brake lever relative to the handlebar, wherein the left integrated brake lever is attached to the left shifter with integrated brake unit; and
securing the left shifter with integrated brake unit to the handlebar.

5. The method of aligning bicycle componentry relative to bicycle handlebar as claimed in claim 1 further comprises the steps of:
aligning a right brake lever relative to the handlebar, wherein the right brake lever is attached to the right brake unit;
aligning a right shifter lever relative to the handlebar, wherein the right shifter lever is attached to the right shifter unit; and
securing the right brake unit and the right shifter unit to the handlebar.

6. The method of aligning bicycle componentry relative to bicycle handlebar as claimed in claim 1 further comprises the steps of:
aligning a right integrated brake lever relative to the handlebar, wherein the right integrated brake lever is attached to the right shifter with integrated brake unit; and
securing the right shifter with integrated brake unit to the handlebar.
